(19) United States
(12) Patent Application Publication
(10) Pub. No.: US 2017/0256774 A1
(43) Pub. Date: Sep. 7, 2017

(54) ELECTRICITY STORAGE DEVICE

(71) Applicant: Sumitomo Electric Industries, Ltd., Osaka-shi (JP)

(72) Inventors: Mizuo Iwasaki, Osaka-shi (JP); Yasushi Mochida, Osaka-shi (JP); Takeshi Araya, Nakakoma-gun (JP)

(21) Appl. No.: 15/519,426

(22) PCT Filed: May 22, 2015
(86) PCT No.: PCT/JP2015/064687

§ 371 Date: Apr. 14, 2017

(30) Foreign Application Priority Data
Oct. 16, 2014 (JP) 2014-211852

(51) Int. Cl. H01M 2/30; H01G 11/80; H01M 2/08; H01G 11/74; H01M 2/04; H01M 2/06; H01G 11/82; H01G 11/52

(52) U.S. Cl. CPC H01M 2/30; H01G 11/82; H01G 11/80; H01G 11/52; H01G 11/74; H01M 2/0404; H01M 2/06; H01M 2/08

(57) ABSTRACT

An electricity storage device includes a case and two electrode terminal portions provided in a cover plate of the case. Each of the electrode terminal portions includes (a) a bolt-shaped electrode terminal that has a head portion and a threaded portion and is inserted into a corresponding terminal hole of the cover plate from the inner side of the case, (b) a ring-shaped first gasket between the electrode terminal and a circumferential portion of the corresponding terminal hole, (c) a nut that fixes the electrode terminal to the cover plate, (d) a washer between the nut and the cover plate, (e) a second gasket between the washer and the cover plate, and (f) a third gasket disposed between the head portion of the electrode terminal and the cover plate. Each of the first to third gaskets contains a fluororesin, and an acrylic sealing agent is disposed between each second gasket and a corresponding washer, between the cover plate and each second gasket, between each third gasket and the head portion of a corresponding electrode terminal, and between the cover plate and each third gasket.

### TECHNICAL FIELD

The present invention relates to an electricity storage device and particularly to an improvement in hermeticity of electrode terminal portions of the electricity storage device.

### BACKGROUND ART

Recently, techniques for converting natural energy such as solar light or wind power to electric energy are receiving attention. Nonaqueous electrolyte secondary batteries and nonaqueous electrolyte capacitors are high-energy density electricity storage devices capable of storing a large amount of electric energy, and demand for these nonaqueous electrolyte secondary batteries and capacitors is growing. Among the nonaqueous electrolyte secondary batteries, lithium ion secondary batteries and sodium ion secondary batteries are promising because of their lightweight and high electromotive force. Among the nonaqueous electrolyte capacitors, lithium-ion capacitors are promising.

Generally, an electricity storage device includes a case, an electrode group contained in the case, and an electrolyte contained in the case and has a hermetic structure. The case includes a closed-bottom container body having an opening and a cover plate that closes the opening of the container body. Electrode terminals (or external electrode terminals) electrically connected to electrodes included in the electrode group to take the electricity to the outside of the case are provided in the case. One example of the structure of the electrode terminals is a structure in which the electrode terminals protrude outward from the inner side of the case through holes (also referred to as terminal holes) formed in the case.

For example, in PTL 1, electrode terminals are inserted into holes formed in a lid of a case, and spaces between the electrode terminals and circumferential portions of the holes are filled with a seal material.

PTL 2 proposes the following. Peripheral portions of holes formed in a lid of a case are bent outward from the inner side of the case to thereby form flanged portions, and these flanged portions are used to fix electrode terminals by crimping. Specifically, members formed from a seal material are disposed between the flanged portions and electrode terminals inserted into the holes, and the flanged portions are pressed against the electrode terminals to crimp the flanged portions.

### CITATION LIST

### Patent Literature

PTL 1: Japanese Unexamined Patent Application Publication No. 2009-48969

PTL 2: Japanese Unexamined Patent Application Publication No. 2012-238510

### SUMMARY OF INVENTION

### Technical Problem

When the seal material is simply embedded in the spaces between the electrode terminals and the circumferential portions of the holes as in PTL 1 and PTL 2, leakage of the electrolyte may not be prevented sufficiently. A terminal structure that utilizes a nut screwed onto a bolt (hereinafter referred to simply as a bolt terminal structure) is also contemplate. The bolt terminal structure is formed, for example, by forming a terminal hole in a case (e.g., a cover plate), inserting a bolt-shaped electrode terminal into the terminal hole from the inner side of the case to the outer side, and screwing a nut onto a threaded portion of the electrode terminal that protrudes outward from the case to thereby fix the electrode terminal to the case. The electrode terminal has the threaded portion (a leg portion or a shaft portion) and a head portion having a size larger than the diameter of the threaded portion. The electrode terminal is used with the threaded portion protruding outward from the terminal hole while the head portion remains in the case. In the bolt terminal structure, a ring-shaped insulating gasket (or an insulating shaft) is disposed between a circumferential portion of the terminal hole and the electrode terminal, and an O-ring-like insulating gasket is disposed between the nut and the cover plate. An O-ring-like washer is disposed between the gasket and the nut. Inside the case, an insulating gasket is disposed between the cover plate and the head portion of the electrode terminal, and, if necessary, a washer may be disposed between this gasket and the head portion of the electrode terminal.

In the bolt terminal structure, the gaskets, washers, etc. are used in order to improve the hermeticity of the electricity storage device, to protect the cover plate, and/or to prevent loosening of the nut. Generally, a material, such as polypropylene, which can easily ensure hermeticity is used for the gaskets. However, when the gaskets used contain polypropylene, the nut may loosen, so that the leakage of the electrolyte may not be sufficiently prevented.

It is an object of the present invention to prevent the leakage of the electrolyte in an electricity storage device having the bolt terminal structure.

### Solution to Problem

One aspect of the present invention relates to an electricity storage device comprising: a case; an electrode group contained in the case; a nonaqueous electrolyte contained in the case; and two electrode terminal portions provided in the case,

wherein the electrode group includes a positive electrode, a negative electrode, and a separator interposed between the positive electrode and the negative electrode,

wherein the case includes a closed-bottom container body having an opening and a cover plate that closes the opening of the container body,

wherein the cover plate has terminal holes for placing the electrode terminal portions,

wherein each of the electrode terminal portions includes

a bolt-shaped electrode terminal that has a head portion and a threaded portion extending from the head portion and is inserted into a corresponding one of the terminal holes from an inner side of the case to an outer side of the case,

a ring-shaped insulating first gasket disposed between the electrode terminal and a circumferential portion of the corresponding one of the terminal holes,

a nut that fixes the electrode terminal to the cover plate,

a washer disposed between the nut and the cover plate,

an insulating second gasket disposed between the washer and the cover plate, and

an insulating third gasket disposed between the head portion of the electrode terminal and the cover plate,

wherein each of the first gaskets, the second gaskets, and the third gaskets contains a fluororesin,

wherein an acrylic sealing agent is disposed between each of the second gaskets and a corresponding one of the washers, between the cover plate and each of the second gaskets, between each of the third gaskets and the head portion of a corresponding one of the electrode terminals, and between the cover plate and each of the third gaskets,

wherein one of the electrode terminal portions is a positive electrode terminal portion electrically connected to the positive electrode, and

wherein the other one of the electrode terminal portions is a negative electrode terminal portion spaced apart from the positive electrode terminal portion and electrically connected to the negative electrode.

### Advantageous Effects of Invention

According to the present invention, the hermeticity of the bolt terminal structure in the electricity storage device having the bolt terminal structure can be improved, and leakage of the nonaqueous electrolyte can thereby be prevented.

### BRIEF DESCRIPTION OF DRAWINGS

FIG. 1 is a perspective view schematically showing an electricity storage device according to one embodiment of the present invention.

FIG. 2 is a vertical cross-sectional view schematically showing an electrode terminal portion (or a bolt terminal structure) in the electricity storage device in FIG. 1.

### REFERENCE SIGNS LIST

10: case
12: container body
13: cover plate
14: positive electrode terminal portion
15: negative electrode terminal portion
16: breaker valve
17: pressure control valve
20: terminal hole
21: electrode terminal
21a: head portion
21b: threaded portion
22: nut
22a: contact area between nut and electrode terminal
23: first gasket
24: washer
25: second gasket
26: third gasket

### DESCRIPTION OF EMBODIMENTS

### Description of Embodiments of Invention

First, the details of the embodiments of the present invention will be enumerated and described.

One embodiment of the present invention relates to (1) an electricity storage device comprising: a case; an electrode group contained in the case; a nonaqueous electrolyte contained in the case; and two electrode terminal portions provided in the case,

wherein the electrode group includes a positive electrode, a negative electrode, and a separator interposed between the positive electrode and the negative electrode,

wherein the case includes a closed-bottom container body having an opening and a cover plate that closes the opening of the container body,

wherein the cover plate has terminal holes for placing the electrode terminal portions,

wherein each of the electrode terminal portions includes

a bolt-shaped electrode terminal that has a head portion and a threaded portion extending from the head portion and is inserted into a corresponding one of the terminal holes from an inner side of the case to an outer side of the case,

a ring-shaped insulating first gasket disposed between the electrode terminal and a circumferential portion of the corresponding one of the terminal holes,

a nut that fixes the electrode terminal to the cover plate,

a washer disposed between the nut and the cover plate,

an insulating second gasket disposed between the washer and the cover plate, and

an insulating third gasket disposed between the head portion of the electrode terminal and the cover plate,

wherein each of the first gaskets, the second gaskets, and the third gaskets contains a fluororesin,

wherein an acrylic sealing agent is disposed between each of the second gaskets and a corresponding one of the washers, between the cover plate and each of the second gaskets, between each of the third gaskets and the head portion of a corresponding one of the electrode terminals, and between the cover plate and each of the third gaskets,

wherein one of the electrode terminal portions is a positive electrode terminal portion electrically connected to the positive electrode, and

wherein the other one of the electrode terminal portions is a negative electrode terminal portion spaced apart from the positive electrode terminal portion and electrically connected to the negative electrode.

In conventional electricity storage devices, their operating temperature is assumed to be lower than 40° C., and therefore a material, such as polypropylene, which can easily ensure hermeticity is generally used as the material of the gaskets. However, in recent years, there is a growing need for electricity storage devices to have a high operating temperature of 40° C. or higher. Under the circumstances, it is becoming known that, when gaskets containing polypropylene etc. are used in the bolt terminal structure, the gaskets deform and/or deteriorate at relatively high temperature and this causes loosening of the nuts. In this case, it is difficult to ensure hermeticity. In terms of heat resistance, it may be advantageous to use gaskets containing a fluororesin. However, the gaskets containing a fluororesin have a higher surface tension than gaskets containing polypropylene and are likely to cause leakage of the electrolyte.

In the embodiment of the present invention, the bolt terminal structure with which hermeticity is not easily ensured at relatively high temperature is used for the electricity storage device. However, the fluororesin is used for the first, second, and third gaskets, and the acrylic sealing agent is disposed between each second gasket and a corresponding washer, between each second gasket and the cover plate, between each third gasket and the head portion of a corresponding electrode terminal, and between each third gasket and the cover plate. This can improve the hermeticity around the terminal holes, so that loosening of the nuts can also be prevented. Therefore, the overall hermeticity of the bolt terminal structure of the electricity storage device can be improved, and leakage of the electrolyte from the terminal holes can be prevented.

The electricity storage device according to the present embodiment is an electricity storage device containing a nonaqueous electrolyte and is intended to encompass nonaqueous electrolyte secondary batteries, nonaqueous electrolyte capacitors, etc. The nonaqueous electrolyte secondary batteries include lithium ion secondary batteries, sodium ion secondary batteries, etc., and the nonaqueous electrolyte capacitors include lithium-ion capacitors, sodium ion capacitors, etc. The nonaqueous electrolytes include organic electrolytes and molten salts and are distinguished from aqueous electrolyte solutions. The organic electrolyte is composed of an organic solvent and an alkali metal salt. The molten salt is synonymous with a salt in a molten state (fused salt) and is referred to also as an ionic liquid. The ionic liquid is a liquid ionic material composed of anions and cations.

When the electricity storage device is used at a relatively high temperature of 40° C. or higher (e.g., 40 to 90° C.), it is preferable that the electrolyte contains 80% by mass or more of a molten salt. When the electricity storage device is used at a relatively low temperature (e.g., −5° C. to lower than 40° C.), it is preferable that the electrolyte contains 80% or more of an organic electrolyte and contains 50% by mass or more of an organic solvent.

(2) A battery that uses a flame-retardant molten salt as the electrolyte is referred to also as a molten-salt battery. The molten-salt battery has excellent thermal stability, can ensure safety relatively easily, and is suitable for continuous use in a high temperature range of 40° C. or higher. A sodium ion secondary battery that uses a molten salt as the electrolyte is receiving attention because its manufacturing cost is lower than those of other molten-salt batteries. Preferably, the molten salt of the sodium ion secondary battery contains, as the cations, sodium ions and organic cations and contains, as the anions, bis(sulfonyl)amide anions.

(3) Preferably, the sealing agent at least contains solid paraffin and at least one selected from the group consisting of (meth)acrylates, (meth)acrylate oligomers, and reaction products thereof. The above sealing agent has high flexibility even after curing, so that a gap is unlikely to be formed around the gaskets. This can further improve the hermeticity of the bolt terminal structure. In the present description, acrylic acid and methacrylic acid are collectively referred to as (meth)acrylic acid, and acrylates and methacrylates are collectively referred to as (meth)acrylates.

(4) Preferably, the tightening torque between each nut and the head portion of a corresponding electrode terminal is 8 to 12 N·m, and the compression ratio of each second gasket in its thickness direction is 75 to 85%. When the tightening torque and the compression ratio of the second gasket are within the above ranges, the deformation and/or deterioration of the gasket is suppressed, so that the effect of preventing the leakage from the terminal holes is further enhanced. The compression ratio of the gasket in its thickness direction means the ratio (%) of the thickness of the gasket after compression with the ratio of the thickness of the uncompressed gasket set to 100%.

(5) The operating temperature of the electricity storage device may be 40 to 90° C. Even when the operating temperature is as described above, the combined use of the acrylic sealing agent and the gaskets containing the fluororesin can suppress the deterioration of the sealing agent, so that the loosening of the nuts can be prevented.

(6) In a preferred embodiment, an acrylic adhesive is disposed between each electrode terminal and a corresponding nut. In this embodiment, the effect of preventing the loosening of the nuts is further enhanced, so that the hermeticity of the bolt terminal structure can be further improved.

### Details of Embodiments of Invention

A specific example of an electricity storage device according to an embodiment of the present invention will next be described with appropriate reference to the drawings. However, the present invention is not limited to this example. The present invention is defined by the scope of the appended claims and is intended to include any modifications within the scope of the claims and meaning equivalent to the scope of the claims.

The electricity storage device includes a case, an electrode group contained in the case, a nonaqueous electrolyte contained in the case, and two electrode terminal portions provided in the case.

The components of the electricity storage device will next be described in more detail.

### (Electrode Terminal Portions (or Bolt Terminal Structure))

The electricity storage device has the two electrode terminal portions provided in the case. One of the two electrode terminal portions is a positive electrode terminal portion, and the other is a negative electrode terminal portion. The positive electrode terminal portion is electrically connected to a positive electrode included in the electrode group, and the negative electrode terminal portion is electrically connected to a negative electrode included in the electrode group. The positive and negative electrode terminal portions are spaced apart from each other in the case.

The case includes a closed-bottom container body having an opening and a cover plate (or a lid) that closes the opening of the container body. The cover plate includes terminal holes for placing the electrode terminal portions. Specifically, the electrode terminal portions are disposed in the cover plate of the case.

Each of the two electrode terminal portions includes a bolt-shaped electrode terminal, a nut, insulating first to third gaskets, and a washer.

Each of the bolt-shaped electrode terminals (positive and negative electrode terminals) includes a head portion and a threaded portion (or a leg portion) extending from the head portion. The threaded portion has a diameter smaller than the size of the head portion, and the electrode terminal is inserted into a corresponding terminal hole from the inner side of the case to the outer side with the threaded portion facing outward. In each electrode terminal portion, the head portion of the electrode terminal is located within the case, and a region of the threaded portion that includes its front end protrudes outward from the case. The threaded portion of the electrode terminal has a columnar shape, and a thread groove is formed on at least the circumferential surface (part of the circumferential surface or the entire circumferential surface) of the threaded portion that is exposed to the outside of the case.

The head portion of the electrode terminal may be a flange portion having a flange-like shape. The flange portion is formed to be larger than the terminal hole so that the electrode terminal is prevented from passing through the terminal hole, and this allows a lead to be easily welded. The head portion (or the flange portion) of the electrode terminal may function as a terminal current collector. Specifically, the head portion of the electrode terminal may have a structure integrated with the terminal current collector. No particular limitation is imposed on the shape of the head portion (or the flange portion) of the electrode terminal. When the head portion is viewed in a direction parallel to the length direction of the electrode terminal, the head portion may have, for example, a tetragonal, circular, or elliptical shape. The head portion (or the flange portion) of the electrode terminal may have a bent portion formed by bending part of the head portion (e.g., a prescribed width region of an edge section of a tetragonal head portion or flange portion).

In each electrode terminal portion, the nut having a thread groove on its inner circumferential surface (or inner wall) is screwed onto the threaded portion protruding outward from the case, and the electrode terminal is thereby fixed to the cover plate. By adjusting the degree of screwing of the nut onto the electrode terminal, the tightening force between the nut and the head portion of the electrode terminal can be adjusted. The electrode terminal portion has the above-described structure that utilizes the screwing of the nut onto the bolt (i.e., the bolt-shaped electrode terminal), and this structure of the electrode terminal portion may be referred to as a bolt terminal structure.

When the electrode terminal (specifically, the leg portion (or the threaded portion)) is inserted into the terminal hole, a gap is formed between a circumferential portion of the terminal hole and the electrode terminal (i.e., the leg portion). The ring-shaped first gasket is disposed in the gap, and this can improve the hermeticity of the bolt terminal structure. In other words, the ring-shaped first gasket is disposed between the circumferential portion of the terminal hole and the electrode terminal (specifically, the leg portion of the electrode terminal inserted into the terminal hole). The first gasket is insulative and insulates the cover plate (the circumferential portion of the terminal hole) from the electrode terminal.

The washer (first washer) is disposed between the nut and the cover plate, and the second gasket is disposed between the washer and the cover plate. The third gasket is disposed between the head portion of the electrode terminal and the cover plate. Specifically, the washer and the second gasket are disposed outside the case, and the third gasket is disposed inside the case. If necessary, a washer (second washer) may be disposed between the head portion of the electrode terminal and the third gasket.

No particular limitation is imposed on the shapes of the washers (first and second washers), the second gasket, and the third gasket, so long as they have holes that allow the leg portion of the electrode terminal to pass therethrough. The second gasket has preferably a ring shape and more preferably an O-ring-like shape. Preferably, the third gasket has a hole through which the leg portion of the electrode terminal passes and has a shape that can prevent the head portion of the electrode terminal (or the second washer) from coming into contact with the cover plate, for example, the same shape as the head portion of the electrode terminal (or the second washer). The second washer may have a ring shape similar to the shape of the first washer or may have a tetragonal, circular, or elliptical shape, as does the head portion of the electrode terminal (or the flange portion), so long as the second washer has a hole through which the leg portion of the electrode terminal passes. When the washers, the second gasket, and the third gasket have the shapes described above, the hermeticity around the terminal hole can be more easily improved.

Each of the washers functions as a cushioning material between the nut and the cover plate or between the head portion of the electrode terminal and the cover plate. The use of the washers prevents damage to the cover plate when the nut is tightened. In many cases, the washers are made of a metal (such as aluminum or an aluminum alloy).

The second and third gaskets are both insulative. The use of these gaskets can ensure insulation between the cover plate and the washer (first washer) and insulation between the cover plate and the head portion of the electrode terminal (or the second washer).

Each of the first to third gaskets contains a fluororesin. The service temperature range of electricity storage devices is being extended. In particular, the operating temperature of molten-salt batteries is relatively high, and their gaskets are required to have heat resistance. Therefore, it is advantageous to use a high-heat resistant fluororesin for the gaskets. However, since the surface tension on the fluororesin is high, leakage of the electrolyte is likely to occur.

In the embodiment of the present invention, an acrylic sealing agent is disposed between the second gasket and the washer (first washer), between the second gasket and the cover plate, between the third gasket and the head portion of the electrode terminal, and between the third gasket and the cover plate. By disposing the acrylic sealing agent in these regions and fastening and fixing the nut to the electrode terminal, the formation of a gap between the head portion of the electrode terminal and the nut is prevented. Although the details are not clear, the acrylic sealing agent may have higher heat resistance and/or higher resistance to the electrolyte than other sealing agents such as rubber-based sealing agents and silicone-based sealing agents. However, the acrylic sealing agent can easily react with a general gasket material (e.g., polypropylene) and may cause degradation of the gasket. The gasket degraded by the sealing agent is more easily degraded by the contact with the electrolyte, causing a loss of hermeticity. Therefore, the acrylic sealing agent is generally not used as the sealing agent for gaskets and is used as a seal material between metals. In the embodiment of the present invention, the gaskets used contain the fluororesin. Therefore, even when the acrylic sealing agent is used, the degradation of the gaskets is suppressed, and this may allow high hermeticity to be ensured in the bolt terminal structure. Then, the leakage of the electrolyte from the terminal hole can be prevented.

The electrode terminal portions (or the bolt terminal structure) will be described in more detail with reference to the drawings.

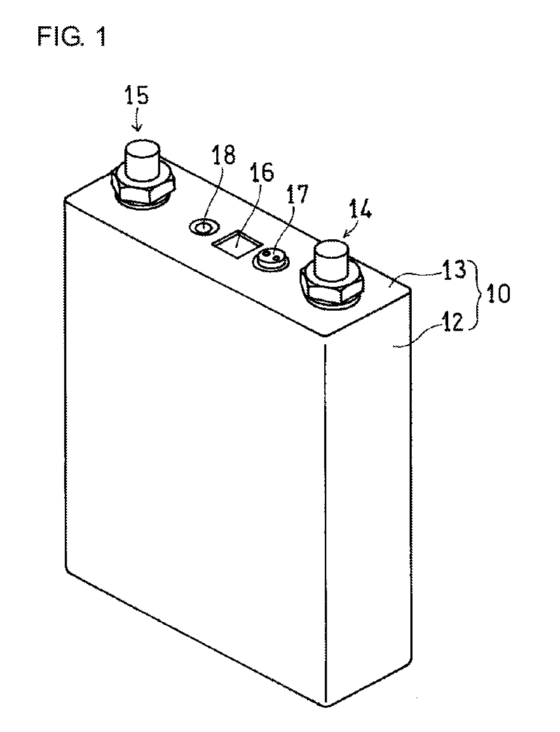

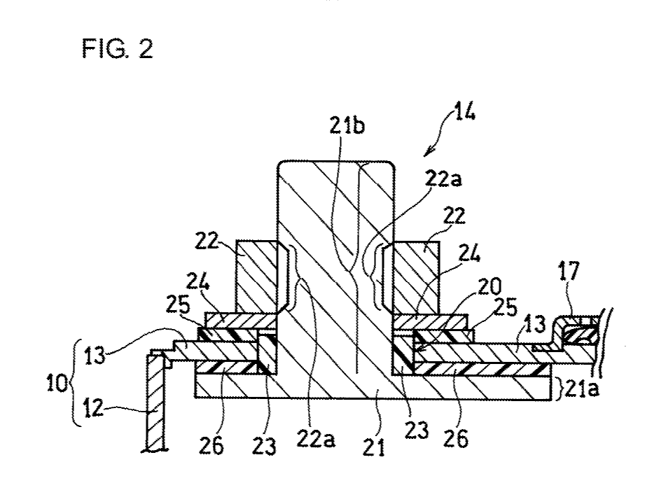

FIG. 1 is a perspective view schematically showing an electricity storage device according to one embodiment of the present invention. FIG. 2 is a vertical cross-sectional view schematically showing an electrode terminal portion (a positive electrode terminal portion) of the electricity storage device in FIG. 1.

The electricity storage device has a rectangular shape and includes an unillustrated stacked electrode group, an unillustrated nonaqueous electrolyte, and an aluminum-made rectangular case 10 that contains the electrode group and the nonaqueous electrolyte. The case 10 includes a closed-bottom container body (outer package can) 12 having an upper opening and a cover plate (lid) 13 that closes the upper opening.

The cover plate 13 includes two electrode terminal portions, i.e., a positive electrode terminal portion 14 and a negative electrode terminal portion 15, spaced apart from each other. A breaker valve 16 that breaks when the internal pressure of the electricity storage device exceeds a prescribed value to thereby reduce the internal pressure of the electricity storage device is disposed near a central portion between the positive electrode terminal portion 14 and the negative electrode terminal portion 15. An electrolyte inlet (not shown) is disposed between the breaker valve 16 and the negative electrode terminal portion 15 and is sealed by a sealing plug 18. A pressure control valve 17 is disposed between the breaker valve 16 and the positive electrode terminal portion 14.

FIG. 2 shows the structure of one of the electrode terminal portions (the positive electrode terminal portion 14). The structure of the positive electrode terminal portion 14 (the bolt terminal structure) will next be described. The structure of the negative electrode terminal portion 15 is the same as the structure of the positive electrode terminal portion 14, and the following description can be referred to.

The positive electrode terminal portion 14 includes: a bolt-shaped electrode terminal 21 having a head portion 21a and a threaded portion 21b extending from the head portion 21a; and a nut 22 screwed onto the threaded portion 21b of the electrode terminal 21. The electrode terminal 21 is inserted into a circular terminal hole 20 formed in the cover plate 13 from the inner side of the case 10 to the outer side. A ring-shaped first gasket 23 is disposed between a circumferential portion of the terminal hole 20 and the threaded portion 21b of the electrode terminal 21. The first gasket 23 is attached to the base of the threaded portion 21b of the electrode terminal 21.

In the electrode terminal 21, the threaded portion 21b is inserted into the terminal hole 20 from the inner side of the case 10 to the outer side, and a part of the threaded portion 21b that includes its front end protrudes outward from the case 10. The head portion 21a has a size larger than the diameter of the terminal hole 20 and is therefore disposed inside the case 10. The nut 22 is screwed onto the threaded portion 21b protruding outward from the cover plate 13 and is tightened against the head portion 21a, and the electrode terminal 21 is thereby fixed to the cover plate 13.

An O-ring-like metallic washer 24 is disposed between the nut 22 and the cover plate 13, and an O-ring-like insulating second gasket 25 is disposed between the washer 24 and the cover plate 13. An insulating third gasket 26 is disposed between the head portion 21a of the electrode terminal 21 and the cover plate 13. The third gasket 26 has the same shape and size as the head portion 21a of the electrode terminal 21 except that a hole for inserting the threaded portion 21b is formed.

The first gasket 23 is disposed between the threaded portion 21b and circumferential portions of the terminal hole 20 and the holes formed in the second gasket 25 and the third gasket 26. Specifically, the holes formed in the second gasket 25 and the third gasket 26 and the terminal hole 20 have the same size, and this size is set such that the threaded portion 21b with the first gasket 23 attached thereto can pass through these holes. The hole formed in the washer 24 is smaller than the outer diameter of the first gasket 23 and larger than the diameter of the threaded portion 21b, in order to prevent the misalignment of the first gasket 23.

An acrylic sealing agent is disposed between the second gasket 25 and the washer 24 within the area of contact between the second gasket 25 and the washer 24 and between the second gasket 25 and the cover plate 13 within the area of contact between the second gasket 25 and the cover plate 13. The acrylic sealing agent is also disposed between the third gasket 26 and the cover plate 13 within the area of contact between the third gasket 26 and the cover plate 13 and between the third gasket 26 and the head portion 21a within the area of contact between the third gasket 26 and the head portion 21a. Generally, in the areas of contact described above, the sealing agent and/or the gaskets are likely to deteriorate during repeated use of the electricity storage device. When the sealing agent and/or the gaskets deteriorate, a gap is formed around the terminal hole 20, and the electrolyte easily leaks. In the embodiment of the present invention, the gaskets used contain the fluororesin, and this can prevent the deterioration of the gaskets and allows the acrylic sealing agent to be used. By disposing the acrylic sealing agent in the areas of contact described above, the deterioration of the sealing agent is prevented, and the formation of a gap is prevented. Therefore, the leakage of the electrolyte from the terminal hole 20 can be prevented.

With the nut 22 tightened against the electrode terminal 21, an adhesive such as an acrylic adhesive is disposed between the nut 22 and the electrode terminal 21 (i.e., the threaded portion 21b) within the area of contact 22a between the nut 22 and the electrode terminal 21. The use of the adhesive allows the nut 22 to be firmly fixed to the electrode terminal 21, and the loosening of the nut 22 can be more effectively prevented even after repeated use of the electricity storage device.

In FIG. 1, the electrolyte inlet is a hole for injecting the electrolyte into the case 10 after the electrode group is placed inside the container body 12 and the cover plate 13 is welded to the opening of the container body 12. After completion of the injection of the electrolyte into the case 10, the electrolyte inlet is sealed by the sealing plug 18.

The breaker valve 16 and the pressure control valve 17 operate according to the internal pressure of the electricity storage device. The prescribed internal pressure of the electricity storage device at which the breaker valve 16 breaks is set to be higher than the operating pressure of the pressure control valve 17, and the breaker valve 16 is configured to operate only when the pressure control valve 17 malfunctions and the internal pressure of the electricity storage device increases excessively. The electricity storage device does not necessarily include both the breaker valve 16 and the pressure control valve 17 and may include one of them.

The case (the container body and the cover plate) is made of a metal. The material of the case may be, for example, aluminum, an aluminum alloy, iron, and/or stainless steel. The case may be plated as needed.

In each of the electrode terminal portions, the electrode terminal is made of a metal. The material of the positive electrode terminal may be, for example, aluminum and/or an aluminum alloy. The material of the negative electrode terminal may be, for example, copper, a copper alloy, nickel, and/or a nickel alloy. The washers are also made of a metal. Examples of the material of the washers include the materials exemplified for the positive electrode terminal and the negative electrode terminal. Preferably, the material of the washer is, for example, aluminum and/or an aluminum alloy.

In each of the electrode terminal portions, the first to third gaskets contain the fluororesin. Examples of the fluororesin include: homopolymers and copolymers of tetrafluoroethylene such as polytetrafluoroethylene (PTFE), tetrafluoroethylene-hexafluoropropylene copolymers, and tetrafluoroethylene-perfluoro(alkyl vinyl ether) copolymers (PFA); polychlorotrifluoroethylene; and polyvinylidene fluoride. Each of the gaskets may contain one of these fluororesins or may contains a combination of two or more of them. Of these, homopolymers and copolymers of tetrafluoroethylene are preferable, and PTFE and/or PFA is particularly preferable.

In the embodiment of the present invention, the acrylic sealing agent is disposed around the second and third gaskets. This can ensure the hermeticity around the second and third gaskets. The acrylic sealing agent may be disposed also around the first gasket. When the acrylic sealing agent is disposed around the second and third gaskets, the acrylic sealing agent may spread around the periphery of the first gasket. However, this is also included in the embodiment of the present invention. Specifically, the periphery of the first gasket may be: a portion between the outer circumferential surface of the ring-shaped first gasket and a surface of the cover plate that is formed in the circumferential portion of the terminal hole; a portion between the outer circumferential surface of the first gasket and the inner circumferential surface of the second gasket; a portion between the outer circumferential surface of the first gasket and the inner circumferential surface of the third gasket; a portion between the inner circumferential surface of the first gasket and the leg portion (threaded portion) of the electrode terminal; a portion between a side surface of the first gasket and the head portion of the electrode terminal (or the second washer); and/or a portion between a side surface of the first gasket and the washer (first washer).

Preferably, the acrylic sealing agent used contains at least an acrylic monomer and/or an acrylic oligomer. Preferably, the above acrylic monomer and the acrylic monomer forming the acrylic oligomer each have at least a (meth)acryloyloxy group. These acrylic monomers may have one (meth)acryloyloxy group or may have two or more (e.g., 2 to 4) (meth)acryloyloxy groups. An acryloyloxy group CH₂═CH—C(═O)—O— and a methacryloyloxy group CH₂═C(—CH₃)—C(═O)—O— are collectively referred to as a (meth)acryloyloxy group.

Examples of the acrylic monomers include: (meth)acrylic acid; and (meth)acrylates such as alkyl (meth)acrylates (e.g., ethyl acrylate and ethyl methacrylate) and hydroxyalkyl (meth)acrylates (e.g., 2-hydroxyethyl methacrylate). The (meth)acrylates also include poly(meth)acrylates of polyols (e.g., diols and triols) such as ethylene glycol di(meth)acrylate and trimethylolpropane tri(meth)acrylate. Acrylates and methacrylates are collectively referred to as (meth)acrylates.

One of the above monomers may be used for the sealing agent, or a combination of two or more monomers may be used. The acrylic oligomer may contain one of the above monomer units or may contain a combination or two or more monomer units. The monomer and oligomer are preferably a (meth)acrylate and/or a (meth)acrylate oligomer.

The acrylic sealing agent may further contain, for example, a polymerization initiator (such as an organic peroxide) and/or a curing agent. The acrylic sealing agent may be any of an organic solvent type (or solvent type) sealing agent, a solventless type sealing agent, and an emulsion type sealing agent. The acrylic sealing agent used may be any of a one-component curing type sealing agent and a two-component curing type sealing agent. The acrylic sealing agent used is applied to at least the peripheries of the second and third gaskets and then cured. No particular limitation is imposed on the type of curing of the acrylic sealing agent, and the acrylic sealing agent may be of the heat curing type, the curing agent-mixing type, the anaerobic curing type, the ultraviolet curing type, etc. The sealing agent is disposed in the area of contact between a gasket and a washer, between a gasket and the cover plate, or between a gasket and the electrode terminal. In these areas of contact, an anaerobic curing type acrylic sealing agent is suitable because the contact with air is easily blocked and the washers, the cover plate, and the electrode terminal are all made of metal.

The cured acrylic sealing agent contains the reaction product of the above-described monomer and/or oligomer. Specifically, in the bolt terminal structure, the acrylic sealing agent (or the cured sealing agent) disposed around the second and third gaskets (and around the first gasket) contains at least one selected from the group consisting of the above-described monomer, the above-described oligomer, and the reaction products thereof

Preferably, the sealing agent further contains solid paraffin (paraffin wax). When the sealing agent contains solid paraffin, the sealing agent can maintain relatively high flexibility even after curing. Therefore, the formation of a gap around the gaskets can be more effectively prevented, and high hermeticity can be obtained. The solid paraffin mainly contains normal paraffins having 20 or more carbon atoms. Preferably, the melting point of the solid paraffin is higher than room temperature (25° C.) and also higher than the operating temperature of the electricity storage device. The melting point of the solid paraffin is preferably 60 to 150° C. and more preferably 90 to 150° C.

When the sealing agent contains the solid paraffin, the hardness (or flexibility) of the cured sealing agent can be adjusted by adjusting the content of the solid paraffin in the sealing agent. The content of the solid paraffin may be adjusted according to the material and/or surface roughness of areas in contact with the sealing agent in the washers, the cover plate, and/or the head portion of the electrode terminal. The content of the solid paraffin in the cured sealing agent is preferably 0.5 to 15% by mass and more preferably 1 to 10% by mass. When the content of the solid paraffin is within the above range, the cured sealing agent can easily maintain appropriate flexibility.

The sealing agent may further contain a filler. Preferably, the filler used is, for example, an inorganic filler such as silica (e.g., ceramic particles). When the sealing agent used contains the filler, the hardness (or flexibility) of the cured sealing agent can be easily adjusted. When the sealing agent contains the filler, the content of the filler in the cured sealing agent (specifically, the content of the filler with respect to the amount of solids in the sealing agent) is preferably 0.5 to 15% by mass and more preferably 1 to 10% by mass. When the content of the filler is within the above range, the cured sealing agent can easily maintain appropriate flexibility.

In the embodiment of the present invention, high hermeticity can be ensured in the bolt terminal structure. Therefore, it is not always necessary to dispose the adhesive between the electrode terminal and the nut. When the adhesive is disposed, the loosening of the nut can be further prevented. The adhesive used may be a rubber-based adhesive, a silicone-based adhesive, etc. Preferably, an acrylic adhesive is used. When the acrylic adhesive is used in the electricity storage device according to the embodiment of the present invention, the effect of preventing the loosening of the nut is higher than that when a different adhesive is used, although the details are not clear. Therefore, the hermeticity of the bolt terminal structure can be ensured for a long time even after repeated use of the electricity storage device, and the effect of preventing the leakage of the electrolyte can be further improved.

The acrylic adhesive contains at least an acrylic monomer. Examples of the acrylic monomer include those exemplified for the acrylic sealing agent. Among these acrylic monomers, (meth)acrylates are preferable.

The acrylic adhesive may further contain a polymerization initiator (such as an organic peroxide) and/or a curing agent. Any known additive may be added to the acrylic adhesive. The acrylic adhesive may be any of an organic solvent type (or solvent type) sealing agent, a solventless type sealing agent, and an emulsion type sealing agent. The acrylic sealing agent used may be any of a one-component curing type sealing agent and a two-component curing type sealing agent. No particular limitation is imposed on the type of curing of the acrylic adhesive, and the type of curing may be appropriately selected from those exemplified for the acrylic sealing agent. The acrylic adhesive is also preferably an anaerobic curing type adhesive. The cured acrylic adhesive contains the reaction product of the above-described monomer.

In each of the electrode terminal portions, by increasing the tightening force between the nut and the head portion of the electrode terminal, the effect of preventing the loosening of the nut and preventing the leakage of the electrolyte from the terminal hole can be further improved. However, in practice, if the tightening force of the nut is excessively large, a high pressure is applied to the gaskets, and the gaskets may easily deform and/or deteriorate. In this case, it is difficult to prevent the leakage of the electrolyte.

The tightening torque between the nut and the head portion of the electrode terminal is, for example, 6 to 16 N·m or 6 to 14 N·m and is preferably more than 6 N·m to 14 N·m and more preferably 8 to 12 N·m. The compression ratio of the second gasket and/or the third gasket with the tightening torque applied is adjusted to, for example, 60 to 90%, preferably more than 60% and less than 90%, and more preferably 75 to 85%. In this manner, the effect of preventing the deformation and/or deterioration of the gaskets is improved, and the leakage of the electrolyte can be further prevented.

The operating temperature of the electricity storage device can be adjusted by changing the composition of the electrolyte. In the embodiment of the present invention, the deterioration of the sealing agent is suppressed even when the operating temperature is high. This can prevent the formation of a gap around the gaskets, so that high hermeticity of the electrode terminal portion can be ensured. Therefore, even when the operating temperature of the electricity storage device is 40° C. or higher, particularly, 60° C. or higher or 80° C. or higher, the leakage of the electrolyte can be effectively prevented. The operating temperature of the electricity storage device is preferably 90° C. or lower.

The components of the electricity storage device other than the electrode terminal portions will next be described in more detail. In the following, a description will be mainly given of the case in which the electricity storage device is a sodium ion secondary battery or a lithium-ion capacitor. In the sodium ion secondary battery, Faradaic reactions involving sodium ions proceed at the positive and negative electrodes. In the lithium-ion capacitor, a non-Faradaic reaction involving adsorption of anions in the electrolyte proceeds at the positive electrode, and a Faradaic reaction involving lithium ions proceeds at the negative electrode.

### (Electrode Group)

The electrode group includes the positive electrode, the negative electrode, and the separator interposed between the positive electrode and the negative electrode.

### (Positive Electrode)

The positive electrode contains a positive electrode active material. The positive electrode may include a positive electrode current collector and the positive electrode active material (or a positive electrode mixture) supported on the positive electrode current collector.

The positive electrode current collector may be a metal foil or may be a metal porous material (such as a metal fiber nonwoven fabric or a metal porous material sheet). The metal porous material used may be a metal porous material having a three-dimensional network skeleton (particularly a hollow skeleton). The material of the positive electrode current collector is preferably aluminum, an aluminum alloy, etc. from the viewpoint of stability at positive electrode potential.

Examples of the positive electrode active material of the sodium ion secondary battery include materials that can occlude and release sodium ions such as compounds containing sodium and a transition metal (a transition metal in the fourth period of the periodic table such as Cr, Mn, Fe, Co, or Ni) (sodium-containing transition metal compounds). In these compounds, at least one of sodium and the transition metal may be partially substituted by a main-group element such as Al.

The sodium-containing transition metal compounds are, for example: sulfides (transition metal sulfides such as TiS₂ and FeS, sodium-containing transition metal sulfides such as NaTiS₂, etc.); oxides [sodium-containing transition metal oxides such as sodium chromite (NaCrO₂), NaNi_{0.5}Mn_{0.5}O₂, and sodium iron-manganate (Na_{2/3}Fe_{1/3}Mn_{2/3}O₂)]; sodium transition metal oxoates; and/or sodium-containing transition metal halides (such as Na₃FeF₆). Of these, sodium chromite, sodium iron-manganate, etc. are preferable. Cr or Na in the sodium chromite may be partially substituted by a different element, and Fe, Mn, or Na in the sodium iron-manganate may be partially substituted by a different element.

A porous material that can reversibly adsorb and desorb anions, e.g., a carbonaceous material, is preferably used as the positive electrode active material of the lithium-ion capacitor. Preferably, the carbonaceous material used is activated carbon, microporous carbon, etc.

The positive electrode mixture may contain, in addition to the positive electrode active material, a conductive assistant and/or a binder. The positive electrode is obtained by applying or filling the positive electrode mixture to or into the positive electrode current collector, drying the positive electrode mixture, and, if necessary, compressing (or rolling) the dried product. Generally, the positive electrode mixture is used in the form of a slurry containing a dispersion medium.

The conductive assistant may be, for example, carbon black, graphite, and/or carbon fibers. The binder may be, for example, a fluororesin, a polyolefin resin, a rubber-like polymer, a polyamide resin, a polyimide resin (such as polyamide-imide), and/or a cellulose ether. The dispersion medium used is, for example, an organic solvent such as N-methyl-2-pyrrolidone (NMP) or water.

### (Negative Electrode)

The negative electrode contains a negative electrode active material. The negative electrode may include a negative electrode current collector and the negative electrode active material (or a negative electrode mixture) supported on the negative electrode current collector.

The negative electrode current collector may be a metal foil or a metal porous material, as is the positive electrode current collector. Preferably, the material of the negative electrode current collector is copper, a copper alloy, nickel, a nickel alloy, stainless steel, etc. because they are not alloyed with sodium and is stable at negative electrode potential.

Examples of the negative electrode active material of the sodium ion secondary battery include materials capable of occluding and releasing metallic sodium and sodium ions, e.g., metals such as titanium, zinc, indium, tin, and silicon, alloys and compounds thereof, and carbonaceous materials. These alloys may contain, in addition to these metals, other alkali metals and/or alkaline earth metals etc. The metal compounds may be, for example, sodium-containing titanium compounds such as sodium titanates (Na₂Ti₃O₇ and/or Na₄Ti₅O₁₂ etc.). In the sodium-containing titanium compounds, titanium or sodium may be partially substituted with other elements. Examples of the carbonaceous material include graphitizable carbon (soft carbon) and non-graphitizable carbon (hard carbon).

As the negative electrode active material of the lithium-ion capacitor, materials capable of occluding and releasing lithium ions, e.g., carbonaceous materials, are preferably used. Preferably, the carbonaceous material used is graphite, graphitizable carbon, non-graphitizable carbon, etc.

The negative electrode can be formed in the same manner as in the formation of the positive electrode. For example, the negative electrode mixture containing the negative electrode active material is applied to or filled into the negative electrode current collector and then dried, and the dried product is compressed (or rolled) in its thickness direction. The negative electrode used may be obtained by forming a deposition film of the negative electrode active material on the surface of the negative electrode current collector by a gas phase method such as vapor deposition or sputtering.

The negative electrode mixture may contain, in addition to the negative electrode active material, a conductive assistant and/or a binder. Generally, the negative electrode mixture is used in the form of a slurry containing a dispersion medium. The conductive assistant, the binder, and the dispersion medium may be appropriately selected from those exemplified for the positive electrode.

### (Separator)

The separator used may be, for example, a resin-made fine porous membrane or a resin-made nonwoven fabric.

The material of the separator may be selected in consideration of the service temperature of the electricity storage device. The resin contained in the fine porous membrane or in fibers forming the nonwoven fabric may be, for example, a polyolefin resin, a polyphenylene sulfide resin, a polyamide resin (an aromatic polyamide resin), and/or a polyimide resin. The fibers forming the nonwoven fabric may be inorganic fibers such as glass fibers. The separator may contain an inorganic filler such as ceramic particles.

### (Electrolyte)

Preferably, the electrolyte of an electricity storage device used at relatively high temperature (e.g., 40° C. or higher) mainly contains a molten salt (ionic liquid) containing cations and anions. The electrolyte may contain, in addition to the molten salt, an organic solvent and/or an additive etc. The content of the molten salt in the electrolyte is preferably 80% by mass or more. The content of the molten salt in the electrolyte is preferably 80 to 100% by mass and may be 90 to 100% by mass.

For example, in the sodium ion secondary battery, it is preferable that the cations include sodium ions (first cations) and organic cations (second cations). The electrolyte containing these cations exhibits sodium ion conductivity and has low viscosity, so that high ion conductivity is easily obtained. However, if the viscosity of the electrolyte is low, the leakage of the electrolyte is likely to occur. However, in the embodiment of the present invention, the hermeticity of the electrode terminal portions can be improved, so that, even when the above-described electrolyte is used, the leakage of the electrolyte can be prevented. A sodium ion secondary battery that mainly uses a molten salt as the electrolyte is referred to also as a sodium molten-salt battery. The concentration of sodium ions in the electrolyte may be appropriately selected, for example, from the range of 0.3 to 10 mol/L.

Examples of the organic cations serving as the second cations include: nitrogen-containing onium cations such as cations derived from aliphatic amines, alicyclic amines, and aromatic amines (e.g., quaternary ammonium cations) and cations having nitrogen-containing heterocycles (i.e., cations derived from cyclic amines); sulfur-containing onium cations; and phosphorus-containing onium cations.

Among these nitrogen-containing organic onium cations, quaternary ammonium cations and cations having nitrogen-containing heterocycle skeletons such as pyrrolidine, pyridine, and imidazole are particularly preferable.

Specific examples of the nitrogen-containing organic onium cations include: tetraalkyl ammonium cations such as tetraethylammonium cations (TEA⁺) and methyltriethyl ammonium cations (TEMA⁺); 1-methyl-1-propylpyrrolidinium cations (MPPY⁺) and 1-butyl-1-methylpyrrolidinium cations (MBPY⁺); and 1-ethyl-3-methylimidazolium cations (EMI⁺) and 1-butyl-3-methylimidazolium cations (BMI⁺). The molten salt may contain one type of second cations or a combination of two or more types.

The cations may further include third cations (specifically inorganic cations other than sodium ions). Examples of the inorganic cations serving as the third cations include alkali metal ions other than sodium ions (such as potassium ions), alkaline earth metal ions (such as magnesium ions and calcium ions), and ammonium ions. The ionic liquid may contain one type of third cations or may contain a combination of two or more types.

Preferably, the anions used are bis(sulfonyl)amide anions.

Examples of the bis(sulfonyl)amide anions include bis(fluorosulfonyl)amide anions (FSA), bis(trifluoromethylsulfonyl)amide anions (TFSA⁻), (fluorosulfonyl)(perfluoroalkylsulfonyl)amide anions [such as (FSO₂)(CF₃SO₂)N⁻)], and bis(perfluoroalkylsulfonyl)amide anions [such as N(SO₂CF₃)₂⁻ and N(SO₂C₂F₅)₂⁻]. Of these, FSA⁻ is particularly preferable.

Preferably, the nonaqueous electrolyte of an electricity storage device used at relatively low temperature (for example, lower than 40° C.) mainly contains an organic electrolyte. The organic electrolyte is composed of an organic solvent and a lithium salt. For example, the electrolyte used for the lithium-ion capacitor may contain, in addition to the organic solvent and the lithium salt, a molten salt and/or an additive etc. The organic solvent and the lithium salt occupy preferably 80% by mass or more and more preferably 90% by mass or more of the electrolyte. Examples of the lithium salt include LiPF₆, LiBF₄, LiClO₄, lithium bis(sulfonyl)amide (LiFSA), and lithium trifluoromethanesulfonate (LiCF₃SO₃). The organic solvent used is a cyclic carbonate (such as ethylene carbonate or propylene carbonate), a chain carbonate (such as diethyl carbonate, dimethyl carbonate, or ethyl methyl carbonate), a cyclic carboxylic acid ester, or a chain carboxylic acid ester.

The electricity storage device can be produced, for example, through (a) the step of forming the electrode group using the positive electrode, the negative electrode, and the separator interposed between the positive electrode and the negative electrode and (b) the step of placing the electrode group and the electrolyte inside the case. The electrode group can be formed by stacking or winding the positive electrode and the negative electrode with the separate therebetween. After the electrode group is placed in the container body of the case, the electrolyte is poured into the container body to impregnate the electrode group with the electrolyte. Alternatively, the electrode group may be impregnated with the electrolyte, and then the electrode group containing the electrolyte may be placed in the container body. After the electrode group and the electrolyte are placed in the container body, the opening of the container body is closed by the cover plate having the electrode terminal portions, and the electricity storage device is thereby obtained.

### EXAMPLES

The present invention will be described specifically by way of Examples and Comparative Example, but the present invention is not limited to the following Examples.

### Example 1

### (1) Production of Positive Electrode

90 Parts by mass of NaCrO₂ (the positive electrode active material), 5 parts by mass of acetylene black (the conductive assistant), and 5 parts by mass of polyvinylidene fluoride (the binder) were dispersed in NMP to prepare a positive electrode mixture paste. The obtained positive electrode mixture paste was applied to both sides of an aluminum foil (length: 10 cm×width: 10 cm, thickness 20 μm), dried sufficiently, and then rolled. In this manner, 100 positive electrodes each having a 60 μm-thick positive electrode mixture layer on both sides and a total thickness of 140 μm were produced. A current collecting lead was formed in one side edge portion of each positive electrode.

### (2) Production of Negative Electrode

95 Parts by mass of hard carbon (the negative electrode active material) and 5 parts by mass of polyamide-imide (the binder) were dispersed in NMP to prepare a negative electrode mixture paste. The obtained negative electrode mixture paste was applied to both sides of an aluminum foil (length: 10 cm×width: 10 cm, thickness 20 μm) used as the negative electrode current collector, dried sufficiently, and then rolled. In this manner, 99 negative electrodes (or negative electrode precursors) each having a 65 μm-thick negative electrode mixture layer on both sides and a total thickness of 150 μm were produced. In addition, two negative electrodes (or negative electrode precursors) were produced in the same manner as above except that the negative electrode mixture layer was formed only on one side of the negative electrode current collector. A current collecting lead was formed in one side edge portion of each negative electrode.

### (3) Assembly of Electrode Group

The positive electrodes and the negative electrodes were stacked with separators interposed therebetween to thereby produce an electrode group. In this case, a negative electrode having the negative electrode mixture layer only on one side was disposed on one end of the electrode group such that the negative electrode mixture layer faced the positive electrodes. Another negative electrode having the negative electrode mixture layer only on one side was disposed on the other end of the electrode group such that the negative electrode mixture layer faced the positive electrodes. The separators used were bag-like fine porous membranes (made of polyolefin, thickness: 50 μm). The positive electrodes were placed inside the bag-like fine porous membranes and then stacked on the negative electrodes.

### (4) Assembly of Sodium Molten-Salt Battery

The electrode group obtained in (3) above and the electrolyte were placed in an aluminum-made container body. An aluminum-made cover plate having two electrode terminal portions shown FIG. 2 was used. The leg portions (threaded portions) of the bolt-shaped electrode terminals were inserted into ring-shaped first gaskets, and each first gasket was attached to the base of a corresponding leg portion. Next, the leg portion with the first gasket attached thereto was inserted into the hole of a third gasket that was formed for insertion of the leg portion of the electrode terminal, and the head portion of the electrode terminal and the third gasket were laid on top of the other. The leg portion of the electrode terminal was inserted into a terminal hole formed in the cover plate from the inner side of the cover plate to the outer side so as to protrude outward from the cover plate. Then the leg portion was inserted into an O-ring-like second gasket and a washer. In this case, the first gasket was disposed between the leg portion and the circumferential portions of the terminal hole and the holes of the second and third gaskets.

Next, the leg portion was inserted into a nut, and the nut was tightened against the head portion with a tightening torque of 10 N·m. The thicknesses of the second and third gaskets were adjusted in advance such that the compression ratios of the second and third gaskets in the thickness direction after the tightening were 80%. The first to third gaskets used were PTFE-made gaskets. Before the assembly of each electrode terminal portion, an acrylic sealing agent (of the two-component anaerobic curing type) containing solid paraffin was applied to the peripheries of the second and third gaskets. Before the nut was fitted, an acrylic adhesive (of the one-component anaerobic curing type) was applied to the leg portion of the electrode terminal. Specifically, in consideration of the thicknesses of the second gasket, the third gasket, the washer, and the cover plate, the acrylic adhesive was applied to a position at which the nut was to be fixed. The content of the solid paraffin in the sealing agent after curing was 1 to 10% by mass.

The leads connected to the positive electrodes of the electrode group were welded to the head portion of the electrode terminal of one of the electrode terminal portions, and the leads connected to negative electrodes were welded to the head portion of the electrode terminal of the other electrode terminal portion. The opening of the container body was sealed by the aluminum-made cover plate, and a sodium molten-salt battery (A) having a nominal capacity of 2.6 Ah was thereby completed as shown in FIG. 1. The electrolyte used was a mixture of sodium bis(fluorosulfonyl)amide NaFSA and 1-methyl-1-propylpyrrolidinium bis(fluorosulfonyl)amide MPPYFSA at a molar ratio of 3:7. Hereinafter, the sodium molten-salt battery will be referred to simply as a molten-salt battery.

Thirty identical molten-salt batteries were produced and divided into a first group, a second group, and a third group each including 10 batteries.

### (5) Evaluation

Each of the molten-salt batteries in the first group was heated to 40° C., charged to 3.3 V at a constant current value corresponding to an hour rate of 0.2 C, and then charged at a constant voltage of 3.3 V. The resulting molten-salt battery was discharged to 1.5 V at a current value corresponding to an hour rate of 0.2 C. This charge-discharge cycle was repeated 10 times.

Each of the molten-salt batteries in the second group was charged and discharged in the same manner as in the first group except that the heating temperature was changed to 60° C. Each of the molten-salt batteries in the third group was charged and discharged in the same manner as in the first group except that the heating temperature was changed to 90° C.

For each of the molten-salt battery groups, the ratio (%) of batteries with electrolyte leakage was computed.

Among the molten-salt batteries in the second group, molten-salt batteries (with no electrolyte leakage) were further subjected to a total of 500 charge-discharge cycles (heating temperature: 60° C.), and the ratio (%) of batteries with electrolyte leakage was computed.

### Example 2

Molten-salt batteries (B) were produced and evaluated in the same manner as in Example 1 except that the acrylic sealing agent used was a one-component anaerobic curing type sealing agent containing silica. The content of silica in the sealing agent after curing was 1 to 10% by mass.

### Comparative Example 1

Electrode terminal portions were formed in the same manner as in Example 1 except that the sealing agent was not applied to the peripheries of the second and third gaskets. Molten-salt batteries (C) were assembled and evaluated in the same manner as in Example 1 except that the cover plate used included the above electrode terminal portions.

### Comparative Example 2

Molten-salt batteries (D) were produced and evaluated in the same manner as in Example 1 except that a rubber-based sealing agent (of the solvent volatilization curing type) was used instead of the acrylic sealing agent.

### Comparative Example 3

Molten-salt batteries (E) were produced and evaluated in the same manner as in Example 1 except that a silicone-based sealing agent (of the moisture curing type) was used instead of the acrylic sealing agent.

The results for the Examples and Comparative Examples are shown in Table 1. The molten-salt batteries A and B are the Examples, and the molten-salt batteries C to E are the Comparative Examples.

TABLE 1

| | | Electrolyte leakage (%) | | | |
|---|---|---|---|---|---|
| | | 10 cycles | | | 500 cycles |
| | Sealing agent | 40° C. | 60° C. | 90° C. | 60° C. |
| A | Acrylic-based (two- | 0 | 0 | 0 | 0 |
| | component type) | | | | |
| B | Acrylic-based (one- | 0 | 0 | 0 | 0 |
| | component type) | | | | |
| C | — | 50 | 60 | 80 | 100 |
| D | Rubber-based (one- | 0 | 40 | 80 | 50 |
| | component type) | | | | |
| E | silicone-based (one- | 0 | 0 | 0 | 100 |
| | component type) | | | | |

In the molten-salt batteries A and B, no electrolyte leakage was found in the electrode terminal portions at all the heating temperatures (i.e., the operating temperatures of the batteries) of 40° C., 60° C., and 90° C. Moreover, no loosening of the nuts was found. Even after 500 repeated charge-discharge cycles, no electrolyte leakage was found. After 500 repeated charge-discharge cycles, each battery was disassembled, and the sealing agent was observed. No changes such as discoloration and deformation were found.

In the molten-salt batteries C in a Comparative Example, even when the operating temperature was 40° C., electrolyte leakage in the electrode terminal portions was found in half of the batteries. The ratio of batteries with electrolyte leakage increased as the operating temperature increased. Electrolyte leakage was found in all the batteries subjected to 500 repeated charge-discharge cycles.

In the molten-salt batteries D in a Comparative Example, no electrolyte leakage occurred when the operating temperature was 40° C. and the number of charge-discharge cycles was small. However, as the operating temperature increased, the ratio of batteries with electrolyte leakage increased. Electrolyte leakage was found in 50% of the batteries subjected to 500 repeated charge-discharge cycles. After 500 repeated charge-discharge cycles, each battery was disassembled, and the sealing agent was observed. The sealing agent was found to have no flexibility. This may indicate that the sealing agent was hardened by thermal deterioration and a gap was formed around the gaskets.

In the molten-salt batteries E in a Comparative Example, no electrolyte leakage was found when the number of charge-discharge cycles was small. However, when the number of charge-discharge cycles was large, electrolyte leakage was found in all the batteries. After 500 repeated charge-discharge cycles, each battery was disassembled, and the sealing agent was observed. The sealing agent was found to be in a swollen state, and discoloration and deformation were found. This may be because of the following. In the batteries E, the silicone-based sealing agent deteriorated due to contact with the electrolyte during repeated charging and discharging. This caused a reduction in sealing characteristics, resulting in a loss of hermeticity.

The evaluation after 500 charge-discharge cycles shown in Table 1 was performed at an operating temperature of 60° C. In the batteries in the Examples, electrolyte leakage was prevented even at an operating temperature of 90° C. in the same manner as that at 60° C. or in a similar manner. In the batteries in the Comparative Examples, electrolyte leakage occurred even at an operating temperature of 40° C.

### Example 3

The tightening torque when the nuts were tightened against the head portions was changed as shown in Table 2 to adjust the compression ratios of the second and third gaskets in the thickness direction to values shown in Table 2. Molten-salt batteries (F to J) were produced in the same manner as in Example 1 except that the tightening torque was changed, and electrolyte leakage was evaluated after the charge-discharge cycle was repeated 500 times.

The results are shown in Table 2. In Table 2, the results for the molten-salt batteries A in Example 1 are also shown.

TABLE 2

| | Tightening torque | Compression ratio | Electrolyte leakage (%) |
|---|---|---|---|
| | (N · m) | (%) | (500 cycles) |
| F | 6 | 90 | 20 |
| G | 8 | 85 | 0 |
| A | 10 | 80 | 0 |
| H | 12 | 75 | 0 |
| I | 14 | 60 | 10 |
| J | 16 | 65 | 30 |

As shown in Table 2, the occurrence of electrolyte leakage after 500 repeated charge-discharge cycles was reduced in all the molten-salt batteries. This may be because of the following. The tightening torque between the nuts and the head portions of the electrode terminals and the compression ratio of the second gaskets and/or the third gaskets are in the appropriate ranges. This allows the effect of preventing the deformation and/or deterioration of the gaskets to be easily obtained. In particular, in batteries G, A, and H, no electrolyte leakage was found at all. From the viewpoint of more effectively preventing the electrolyte leakage, it is preferable that the tightening torque is more than 6 N·m and less than 14 N·m and the compression ratio is more than 60% and less than 90%. In particular, when the tightening torque is 8 to 12 N·m and the compression ratio is 75 to 85%, the effect of preventing the electrolyte leakage can be further improved.

### INDUSTRIAL APPLICABILITY

According to the embodiment of the present invention, electrolyte leakage in the electricity storage device having the bolt terminal structure can be prevented. Therefore, the electricity storage device in the embodiment of the present invention is suitable for various applications such as household and industrial large-sized electric power storage devices, electricity storage devices used as power sources of hybrid vehicles and electric vehicles, and particularly molten-salt batteries used at relatively high temperature.

1. An electricity storage device comprising: a case; an electrode group contained in the case; an electrolyte contained in the case; and two electrode terminal portions provided in the case,
wherein the electrode group includes a positive electrode, a negative electrode, and a separator interposed between the positive electrode and the negative electrode,
wherein the case includes a closed-bottom container body having an opening and a cover plate that closes the opening of the container body,
wherein the cover plate has terminal holes for placing the electrode terminal portions,
wherein each of the electrode terminal portions includes
a bolt-shaped electrode terminal that has a head portion and a threaded portion extending from the head portion and is inserted into a corresponding one of the terminal holes from an inner side of the case to an outer side of the case,
a ring-shaped insulating first gasket disposed between the electrode terminal and a circumferential portion of the corresponding one of the terminal holes,
a nut that fixes the electrode terminal to the cover plate,
a washer disposed between the nut and the cover plate,
an insulating second gasket disposed between the washer and the cover plate, and
an insulating third gasket disposed between the head portion of the electrode terminal and the cover plate,
wherein each of the first gaskets, the second gaskets, and the third gaskets contains a fluororesin,
wherein an acrylic sealing agent is disposed between each of the second gaskets and a corresponding one of the washers, between the cover plate and each of the second gaskets, between each of the third gaskets and the head portion of a corresponding one of the electrode terminals, and between the cover plate and each of the third gaskets,
wherein one of the electrode terminal portions is a positive electrode terminal portion electrically connected to the positive electrode, and
wherein the other one of the electrode terminal portions is a negative electrode terminal portion spaced apart from the positive electrode terminal portion and electrically connected to the negative electrode.

2. The electricity storage device according to claim 1, wherein the sealing agent at least contains solid paraffin and at least one selected from the group consisting of (meth)acrylates, (meth)acrylate oligomers, and reaction products thereof.

3. The electricity storage device according to claim 1, wherein a tightening torque between each of the nuts and the head portion of a corresponding one of the electrode terminals is 8 to 12 N·m, and
a compression ratio of each of the second gaskets in a thickness direction thereof is 75 to 85%.

4. The electricity storage device according to claim 1, wherein an operating temperature of the electricity storage device is 40 to 90° C.

5. The electricity storage device according to claim 1, wherein an acrylic adhesive is disposed between each of the electrode terminals and a corresponding one of the nuts.
